(19) United States
(12) Patent Application Publication
(10) Pub. No.: US 2011/0174932 A1
(43) Pub. Date: Jul. 21, 2011

(54) KITE BASED PLATFORM

(76) Inventor: Alon TELLEM, D.N. Movil (IL)

(21) Appl. No.: 12/689,868

(22) Filed: Jan. 19, 2010

(51) Int. Cl. B64C 31/06

(52) U.S. Cl. 244/155 R

(57) ABSTRACT

A kite-based platform device includes a passive aerodynamically-shaped structure for using aerodynamic lift to lift an end of a tether. The device also includes a payload with a motorized climbing mechanism for attaching to the tether and raising and lowering the payload along the tether.

### FIELD OF THE INVENTION

The present invention relates to kites. More particularly, the present invention relates to a kite based platform.

### BACKGROUND OF THE INVENTION

Aerial observation is advantageous in a wide range of applications. Such applications may include, for example, fire fighting, traffic control, police work, monitoring of outdoor areas, agriculture, animal husbandry, and wildlife monitoring and management.

For example, a firefighter who is fighting a forest fire may find aerial observation useful in fighting the fires. Typically, a firefighter may attempt to contain the fire or to direct the fire by removing inflammable vegetation from fire lines. The vegetation, including trees and bushes, as well a other obstacles or topographical features, may, however, limit the visibility of the firefighter. As a result, the life of the firefighter working on the fire line may be endangered. For example, a firefighter, unable to see the fire under such circumstances, may become surrounded and trapped by a spreading fire that cuts off a line of escape. Government guidelines for firefighting crews require posting lookouts for observing the fire. However, the effectiveness of posting lookouts is limited and, unfortunately, firefighters are sometimes killed due to unexpected behavior of the fire.

Acquiring information by aerial observation may be advantageous under these circumstances. Traditional aerial observation may include mounting cameras and other relevant sensors on a manned or unmanned air vehicle, such as, for example, an airplane, helicopter, satellite, or balloon. However, implementing such traditional aerial observation may be problematic. Air traffic around a fire zone may be strictly controlled and subject to strict safety regulations, prioritizing aerial firefighting measures. Also, even with aerial observation of the fire, it may be difficult to locate an endangered firefighting crew and relay relevant information to the crew in due time. (Transmitting information on a general radio network without specifying the individual crew it is intended for may be unnecessarily confusing to the crews.)

Another possible use of aerial observation is in early detection of forest fires or wildfires. Often, early detection of such a fire is a key element in limiting the damage caused by the fire. For example, the area of a fire zone increases with time.

The conventional solution for early detection of fires traditionally included manned observation towers in the form of lookout towers or fire towers. The fixed location of the towers presented both the advantages and disadvantages. On the one hand, an observation tower may enable frequent coverage of the surrounding terrain, while on the other hand the size of the area covered may be fixed and relatively small. The cost of manning and maintaining a tower may be relatively high. For this reason, a large number of observation towers have been abandoned in recent years.

One possible replacement for an observation tower is to observe a large area using aerial observation. However, the frequency of coverage by aerial observation may be dependent on weather conditions. Therefore, an unacceptable amount of time may pass between the start of a fire and its detection. In addition, a powered aerial observation platform, such as a manned or unmanned air vehicle, may be able to fly for only a limited amount of time. Such vehicles may also be subject to air traffic regulations that limit their use. For example, in some jurisdictions, any object flying above an altitude of about 150 meters or having a mass greater than about 2.5 kilograms may be regulated. Satellite coverage of the area, besides being subject to limitations imposed by cloud coverage and other weather conditions, may be too intermittent to provide adequate coverage in real time.

Kites may be launched and flown for various purposes, for example, to signal a position to aid in rescue operations. Methods of launching kites have been described previously. For example, launching means have been described wherein a collapsed kite is deployed after being launched by a gun, rocket, or similar launching means. For example, launching and deployment of kites have been described by Wheelwright in GB 555542 and McKenzie, Sr. in U.S. Pat. No. 3,787,013. The kites are deployed with the help of relatively stiff frame elements that extend softer flexible elements made of cloth or similar material. Such frame elements may limit the compactness and portability of the collapsed kite prior to deployment. Kempton et al. in AU 2921084, Pascoe et al. in U.S. Pat. No. 5,816,537, Schnee in U.S. Pat. No. 4,768,739, and Veazey in U.S. Pat. No. 5,736,954 describe inflatable kites or airfoils that provide lift when inflated. Duckworth et al. in GB 2098949 and GB 2098950 describes a sail that is unfurled and pulled upward with the help of a pilot kite or sail.

Devices for climbing a tether or string attached to a kite or similar flying object have also been described. For example, Fregeau in U.S. Pat. No. 3,327,976, Parks in U.S. Pat. No. 1,301,967, Armbrust in U.S. Pat. No. 2,446,684, Young in U.S. Pat. No. 2,833,497, Schmidt in U.S. Pat. No. 3,968,948, Newbold in U.S. Pat. No. 4,465,251, Boone in U.S. Pat. No. 3,003,723, and Johnson, Jr. in U.S. Pat. No. 3,023,987 describe employing the wind to raise an object up a kite string. Wang in US 2003/116680 describes using a spring to propel a payload up a kite string. With these devices, there is little or no operator control over the behavior of the climbing device.

Eddy in U.S. Pat. No. 578,980 and Parker in GB 191210432 describe devices for improving the stability of a camera suspended from a kite for the purpose of performing aerial photography. Brown in U.S. Pat. No. 1,002,897 describes a camera suspended by a kite that is operated by a windblown fan.

Thus, there is a need for an aerial observation platform that is compact, that may be deployed and operated by a single person, that may operate for an extended period of time, and that is not subject to air traffic regulations.

It is an object of the present invention to provide an aerial observation platform that is easily deployable without being subject to air traffic regulations, and that may be operated for an extended period of time.

Other aims and advantages of the present invention will become apparent after reading the present invention and reviewing the accompanying drawings.

### SUMMARY OF THE INVENTION

There is thus provided, in accordance with some embodiments of the present invention, a kite-based platform device including a passive aerodynamically-shaped structure for using aerodynamic lift to lift an end of a tether, and a payload including a motorized climbing mechanism for attaching to the tether and raising and lowering the payload along the tether.

Furthermore, in accordance with some embodiments of the present invention, the structure is collapsible so as to be launchable to a predetermined altitude by a launcher and deployable at the predetermined altitude.

Furthermore, in accordance with some embodiments of the present invention, the launcher is selected from a group of launchers consisting of: a mechanical launcher, a pyrotechnic launcher, and a pneumatic launcher.

Furthermore, in accordance with some embodiments of the present invention, the structure when collapsed is at least partially enclosed within a tearable enclosure.

Furthermore, in accordance with some embodiments of the present invention, the angle of attack of the structure relative to the wind is adjustable.

Furthermore, in accordance with some embodiments of the present invention, the motorized climbing mechanism includes a motorized pulley capable of pulling on the tether when the tether is wrapped around the pulley.

Furthermore, in accordance with some embodiments of the present invention, the device includes enclosing plates angled so as to maintain contact between the pulley and the tether when the tether is wrapped around the pulley.

Furthermore, in accordance with some embodiments of the present invention, the device includes a spring and a spacer for angling the enclosing plates.

Furthermore, in accordance with some embodiments of the present invention, the payload comprises a gimbal axis for enabling the payload to rotate about an axis substantially perpendicular to the tether.

Furthermore, in accordance with some embodiments of the present invention, the payload includes stabilizing fins.

Furthermore, in accordance with some embodiments of the present invention, the payload includes a connector for connecting to a sensor.

Furthermore, in accordance with some embodiments of the present invention, the sensor is selected from a group of sensors consisting of: a camera, an anemometer, and a direction sensor.

Furthermore, in accordance with some embodiments of the present invention, the payload includes a communications device for communicating with a remote station.

Furthermore, in accordance with some embodiments of the present invention, the structure is attachable to the tether via a plurality of attachment lines.

Furthermore, in accordance with some embodiments of the present invention, the length of one or more of said two or more attachment lines is adjustable so as to adjust the angle of attack of the structure.

There is further provided in accordance with some embodiments of the present invention a method for deploying a kite-based platform. The method includes: attaching an upper end of a tether to a passive aerodynamically-shaped structure; launching the structure to a predetermined altitude at which the structure is deployed to provide aerodynamic lift; attaching a motorized climbing mechanism of a payload to the tether; and operating the mechanism to raise the payload to a desired altitude.

Furthermore, in accordance with some embodiments of the present invention, the method includes attaching a lower end of the tether to an anchor point.

Furthermore, in accordance with some embodiments of the present invention, the method includes adjusting an angle of attack of the structure such that the deployed structure flies substantially above the anchor point.

Furthermore, in accordance with some embodiments of the present invention, the step of attaching an upper end of the tether to the structure includes attaching a plurality of attachment lines of the structure to the tether and adjusting the length of one or more of the attachment lines so as to adjust the angle of attack of the structure.

Furthermore, in accordance with some embodiments of the present invention, the method includes adjusting the position of a stop on the tether so as to determine the predetermined altitude.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 shows a payload in accordance with some embodiments of the present invention.

FIG. 2A shows a climbing device in accordance with some embodiments of the current invention.

FIG. 2B shows another view of the climbing device shown in FIG. 2A.

FIG. 3A shows a deployed airfoil kite in accordance with some embodiments of the present invention.

FIG. 3B shows an alternative design of a deployed airfoil kite, in accordance with some embodiments of the present invention.

FIG. 3C shows a device for varying the angle of attack of an airfoil kite, in accordance with some embodiments of the present invention.

FIG. 4A shows a launched pack containing a kite, in accordance with embodiments of the present invention.

FIG. 4B shows the pack shown in FIG. 4A prior to launch.

FIG. 4C shows the interior of the pack shown in FIG. 4A.

FIG. 5 shows a mechanical launcher for launching a kite in accordance with embodiments of the present invention.

FIG. 6 schematically illustrates alternative launch mechanisms to the launcher shown in FIG. 5.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Embodiments of the invention may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein.

A platform in accordance with embodiments of the present invention includes a controlled payload. Typically, the payload includes a remotely controllable observation payload. An observation payload may include one or more remotely controllable cameras, operating in one or more spectral ranges. For example, a camera may include sensors and optics for detecting visible light, thermal infrared, or both. In addition to a camera, an observation payload may include various other measurement or observation devices, instruments, or sensors. For example, instruments may include navigational or meteorological measurement devices. For example, the instruments may include a Global Positioning System (GPS) receiver, a compass, altimeter, thermometer, barometer, hygrometer, or anemometer. The observation payload typically includes a receiver for receiving commands and data, typically transmitted from a remote location via a communications channel. The communications channel may include any suitable means of communication, for example, a wire, optical fiber, or a wireless communications channel based on radio, microwave, infrared, or light communications. Typically, the communications channel is a wireless communications channel. Typically, the communications channel may be used to communicate with one or more independent or cooperating remote control, receiving, and transmitting stations, hereinafter referred to collectively as the remote station,

The payload typically includes an appropriate antenna to aid communication with the remote station via a wireless radio channel. The receiver may cooperate with a controller. For example, the controller may control various devices associated with the observation payload in response to commands received from the remote station. An observation payload may also include a transmitter for transmitting data to the remote station via the communications channel. The transmitter may cooperate with the controller or with various devices associated with the observation payload. Typically, the transmitter transmits images and data acquired by devices associated with, or carried by, an observation payload. Typically, the transmitter and receiver may be incorporated in a single transceiver device capable of both transmitting and receiving data over the communications channel.

Typically, a payload in accordance with embodiments of the present invention is able to grip a section of a tether. When the payload is to be used, an upper end of the tether is held aloft. Typically, the upper end of the tether is held aloft by an approximately stationary elevated or airborne object. A lower end of the tether typically remains near an operator on the ground, and is typically anchored. Thus, a payload gripping the tether may be held aloft when the upper end of the tether is held aloft.

A payload in accordance with embodiments of the present invention may be controlled to ascend or descend a tether. For example, the payload may include a motorized shaft about which a section of the tether is looped. The motorized shaft may rotate in response to remotely transmitted instructions received by a receiver associated with of the payload, or in response to instructions generated by a programmed controller. Depending on the direction of rotation of the motorized shaft, the payload may be made to ascend or descend the tether. The payload may thus be controlled to climb the tether to a desired altitude. The payload may then grip a section of the tether at the desired altitude and remain attached to the gripped section of tether.

A tether may be in the form of a string, wire, chain, or rope. Typically, the tether is at least partially in the form of a lightweight, strong string. Typically, the upper end of the tether is held aloft at a desired altitude by, for example, an airborne object. The upper end of the tether is typically attached to an attachment point on the airborne object. The airborne object may typically be an airborne kite. For the purpose of this description, “kite” should be understood as referring to any passive airfoil or other aerodynamically shaped wing or structure capable of providing aerodynamic lift and tethered to an anchor point. A passive aerodynamic structure may provide lift without operating any powered moving parts such as propellers, rotors, or jet or rocket engines. The kite may provide aerodynamic lift in the presence of a wind or other relative motion between the atmosphere and the structure. Alternatively, the tether may be held aloft by any other elevated object that may be made to maintain an approximately stationary position with respect to the ground. Such an object may include, for example, a balloon, mast, tower, building, tree, a manned or unmanned helicopter or aircraft capable of hovering, or by any other object capable of maintaining an attachment point at a desired altitude. The lower end of the tether is typically attached to a winch, reel, or other object located near an operator that deploys the observation platform. Typically, the operator is on the ground, or in or on a vehicle or structure near the ground. (After the kite is fully or partially deployed, an operator who is remotely operating the payload may be free leave the immediate vicinity of the winch.) A winch may be used to vary the length of the tether. For example, varying the length of the tether may be used to control the altitude of a kite that holds the upper end of the tether. The winch may also be used to retract the tether and the kite after use for reuse at a later date.

A kite in accordance with embodiments of the present invention is typically constructed of flexible material such as, for example, cloth, flexible plastic sheet, ripstop nylon, or metal foil. Typically, no frame or other rigid or semi-rigid structural elements are provided. The lack of rigid structural elements enables a lightweight kite that may be stored as folded or collapsed into a compact shape, such as, for example, a cylinder, prior to deployment.

In order for a kite to serve as the upper attachment point for a tether, the kite must be raised to a flying altitude. At a flying altitude, the velocity of the wind is typically sufficient and sufficiently steady to hold the kite aloft for a sufficient period of time. For example, at low altitudes, vegetation or other obstacles may impede or divert the flow of air. For example, the flow of air may be impeded below an altitude approximately 120% of a characteristic obstacle height, for example, about 50 meters. Simply releasing the kite and allowing the lift of the kite to gradually raise the kite into the air from near the ground may thus not be advisable. For example, until the kite rises above obstacles near the ground, the kite or tether may crash into or become entangled in tree branches, electric lines, or other obstacles. Therefore, a kite in accordance with embodiments of the present invention may be provided with an appropriate launcher for launching the kite rapidly to the flying height.

Typically, the kite is launched while it is folded or collapsed. For example, a kite may folded kite may form a compact cylindrical object. Typically, the folded kite may be partially or fully enclosed within a lightweight cover. The lightweight cover is typically constructed of a lightweight, easily tearable material, such as a lightweight cloth or paper. Prior to launch, a free end of a tether may be attached to one or more attachment points on the folded kite. The remainder of the tether may be wound around a reel or winch. The folded kite is loaded into a launcher. The launcher is provided with a mechanism for rapidly accelerating the folded kite over a short distance. The acceleration may be sufficient to launch the folded kite to an altitude at or near a flying altitude. The launcher may include any launch mechanism known in the art. A launcher may typically include a pyrotechnic launch mechanism in which the kite is launched by an explosion of an explosive charge. Alternatively, a launcher may include, for example, a mechanical launch mechanism such as a stretched or flexed elastic element in the form of a spring, coil, elastic band or cord, bendable arm. Alternatively, a launcher may include a hydraulic, pneumatic, or electromagnetic launch mechanism.

When the launched folded kite reaches a predetermined altitude, the kite is unfolded and deployed. For example, as the launched folded kite ascends, it may cause a length of the tether to unwind from the winch. An appropriately positioned stop on the tether or winch may prevent more than a predetermined length of tether to unwind. Alternatively, a predetermined length of tether may be related to the weight of the length of tether that is unwound. When the folded kite reaches the predetermined altitude, the tether exerts a force on the folded kite that may cause the kite to partially unfurl. For example, the tether may cause a lightweight cover that encloses the folded kite to tear open. In addition, a system of one or more cords attached to the tether may pull the kite partially open in a predetermined manner. Wind blowing on the partially opened kite may then cause the kite to fully unfurl. When the kite is fully unfurled, various structures of the kite interact with the wind. The structures interacting with the wind may enable the kite to maintain its shape, to maintain its orientation and angle of attack with respect to the wind, and to provide the required lift. The structures may be adjustable to enable the kite to provide lift under a variety of wind conditions. The angle of attack of the kite may be adjusted, typically prior to launch based on observed wind conditions, so as to cause the kite to fly approximately over the anchor point.

The payload may include one or more structural components for stabilizing the orientation of the payload. For example, the payload may typically include vertical or horizontal stabilizing fins. When the payload is being held aloft, the stabilizing fins may maintain the payload at an approximately constant orientation with respect to a wind direction.

Any cameras and other observation devices of the payload may be remotely operated. Data acquired by the observation devices may be transmitted to one or more receiving devices, typically associated with an operator. Image data acquired from a camera may be processed in order to provide a displayable image that includes useful information.

The orientation of the platform when acquiring images may be at least approximately determined by collecting direction data from one or more sensors. Such sensors may include a magnetic, inertial, or optical compass, or an anemometer.

Image data acquired by the camera may be processed in such a manner so as to reduce the effects of camera and platform motion. Such image processing and stabilization techniques are known in the art.

Reference is now made to the accompanying Figures.

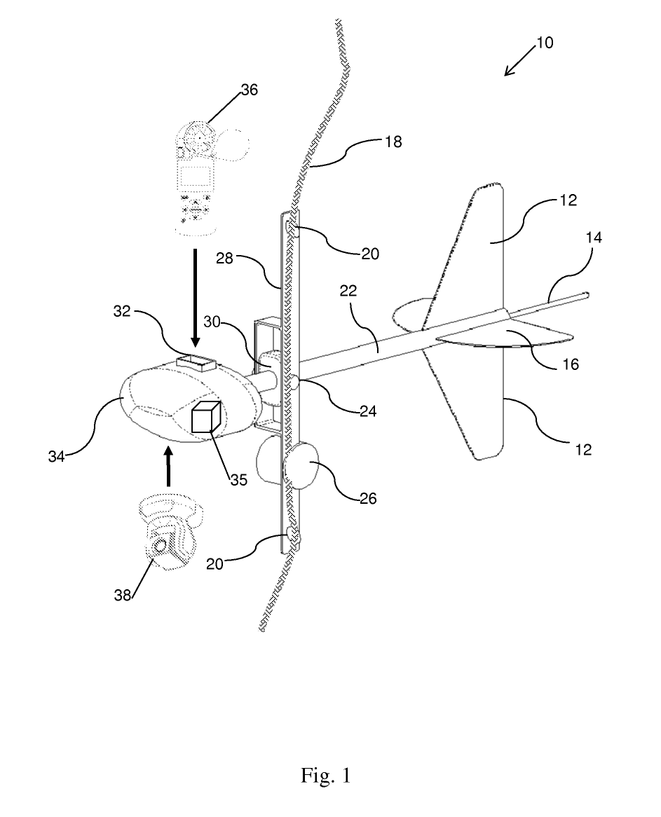

FIG. 1 shows a payload in accordance with some embodiments of the present invention. Payload 10 attaches to, and may be held aloft by, tether 18. Payload 10 may communicate with a remote station, via antenna 14. For example, the remote station may include a control module operated by a remote operator. Payload 10 includes payload core 22. Payload core 22 may include a power source, such as one or more electrical batteries. Typically, the power source includes one or more batteries, for example, providing a voltage of 12 V. Payload core 22 may provide a communication connection between instrument module 34 and antenna 14. One or more independent or cooperating controllers, represented by controller 35, may be enclosed in payload core 22, instrument module 34, or both. Controller 35 may receive commands via antenna 14 from the remote station. Controller 35 may then operate one or more devices associated with payload 10 in response to the received commands. For example, controller 35 may operate climbing device 26 in response to a received command. As another example, controller 35 may operate one or more cameras or sensors. Alternatively or in addition, controller 35 may include programmed instructions that enable at least limited autonomous operation of devices of payload 10 at least partially independently of received commands.

Typically, instrument module 34 encloses, holds, or provides connectors for, one or more sensors. For example, instrument module 34 may include anemometer socket 32. An anemometer, such as anemometer 36, may be inserted into anemometer socket 32. For example, anemometer 36 may be connected to anemometer socket 32 such that a wind velocity and direction measured by anemometer 36 may be acquired by controller 35. The acquired data may then be transmitted via antenna 14 to the remote station. Instrument module 34 may also include a camera 38. Typically, camera 38 is provided with remotely controllable pan, tilt, and zoom controls that enable aiming camera 38 at a desired scene. An acquired image, such as a single frame or video sequence, may be transmitted to the remote station via antenna 14.

Payload 10 includes structural elements for grasping and climbing tether 18. For example, payload 10 may include bar 28. Bar 28 includes two or more clips 20. Clips 20 may confine tether 18 and fix the orientation of bar 28 with respect to tether 18. However, clips 20 enable tether 18 to move parallel to the axis of bar 28. Between clips 20, tether 18 may be looped about a shaft of climbing device 26.

Payload 10 may be attached to tether 18 such as to enable yaw and pitch motion of payload 10. For example, payload 10 is free to yaw or rotate in a plane approximately perpendicular to tether 18 through twisting of tether 18. Payload core 22 may be gripped by balance clamp 30. Typically, the position of balance clamp 30 on payload core 22 may be adjusted such that balance clamp 30 is positioned near or at the center of gravity of payload 10. Balance clamp 30 may be connected to bar 28 via gimbal axis 24, enabling pitch motion of payload 10 about an axis approximately perpendicular to tether 18. Payload 10 may include components for stabilizing yaw and pitch motion with respect to a direction of a wind or other relative motion between payload 10 and the ambient atmosphere. For example, an end of payload core 22 may be provided with vertical fins 12 and with horizontal fins 16. Vertical fins 12 tend to stabilize the yaw of payload 10 with respect to the wind direction. Horizontal fins 16 tend to stabilize the pitch of payload 10 with respect to the wind direction.

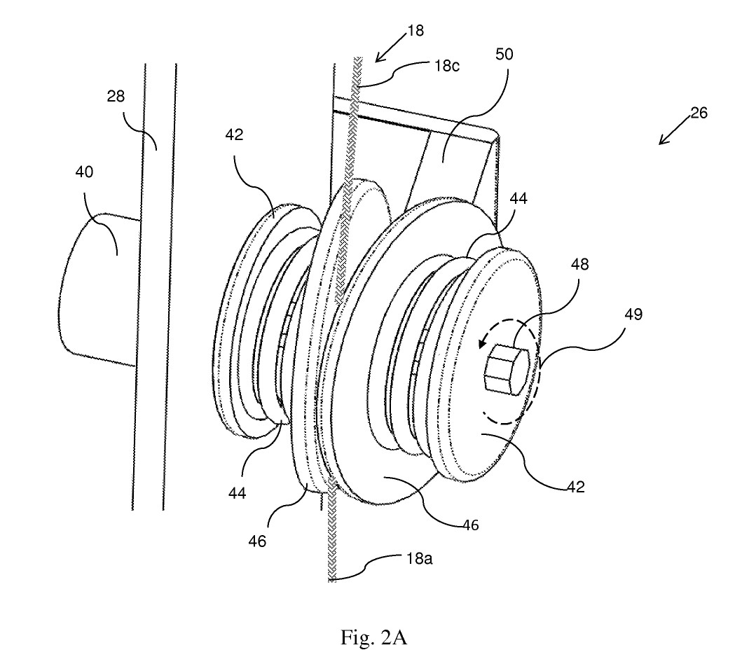

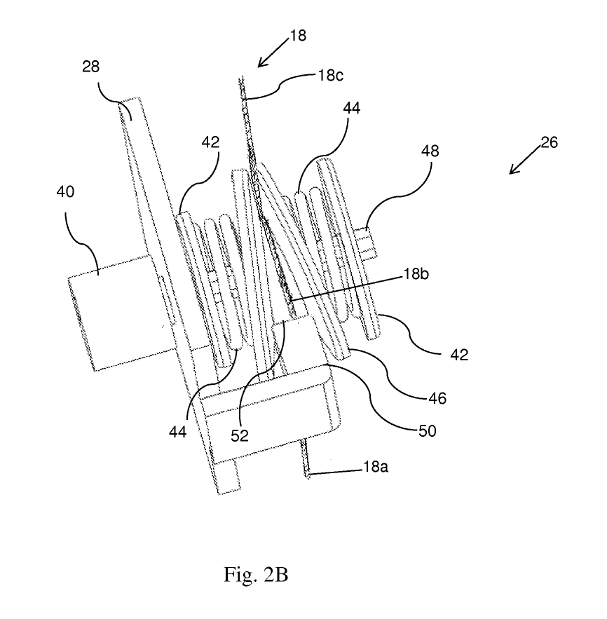

Climbing device 26 may be operated to cause payload 10 to ascend or descent tether 18. FIG. 2A shows a climbing device in accordance with some embodiments of the current invention. FIG. 2B shows another view of the climbing device shown in FIG. 2A. Climbing device 26 includes shaft 48. Shaft 48 is rotatable by motor 40. Motor 40 may be remotely controlled. Tether pulley 52 is mounted on shaft 48 such that rotation of shaft 48 rotates tether pulley 52. Lower tether segment 18a of tether 18 extends below tether pulley 52, while upper tether segment 18c extends above tether pulley 52. Loop segment 18b of tether 18 is looped about tether pulley 52. When motor 40 rotates shaft 48 and tether pulley 52 in the direction indicated by arrow 49, upper tether segment 18c is pulled downward. Downward pulling on upper tether segment 18c may cause climbing device 26 to ascend tether 18. Similarly, rotation of shaft 48 in the direction opposite of that indicated by arrow 49 may cause climbing device 26 to descend tether 18.

Climbing device 26 may be constructed so as to enable attachment to tether 18 on the one hand, and to ensure good contact with tether 18 on the other. Outer plates 42 and springs 44 push inner plates 46 inward, toward each other along shaft 48. Spacer 50 cooperates with springs 44 to cause inner plates 46 to skew diagonally and meet on a side of each inner plate 46 distal to spacer 50. The meeting of inner plates 46 confines tether 18 at the point where upper tether segment 18c and lower tether segment 18a cross to form loop segment 18b. This confinement of tether 18 may ensure sufficient friction between tether 18 and tether pulley 52 to enable ascent or descent of climbing device 26 along tether 18.

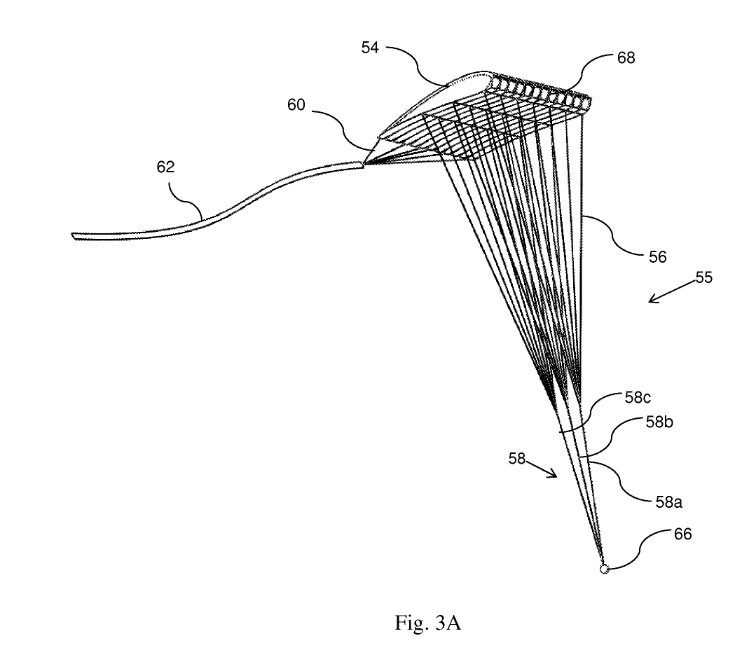

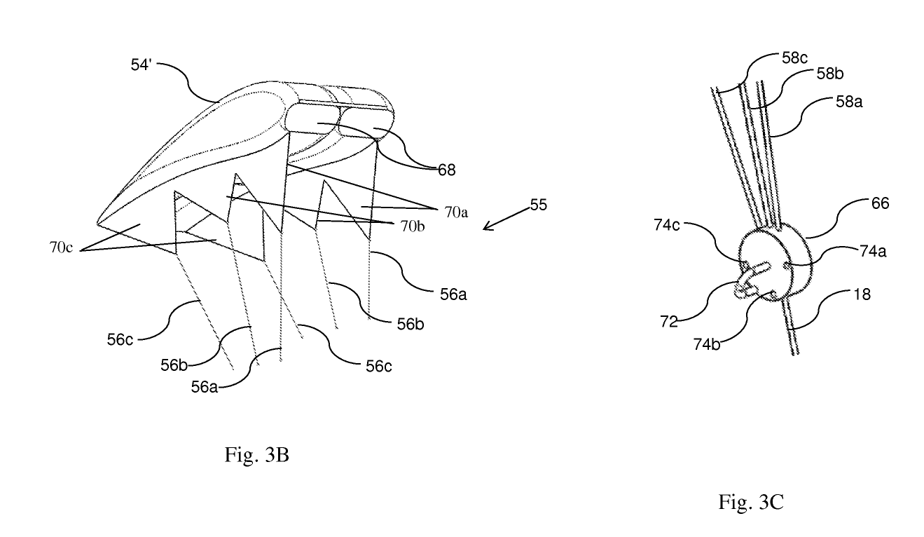

Upper tether segment 18c of tether 18 may be held aloft by a kite. Typically, the kite is in the form of a soft, self inflating, airfoil. FIG. 3A shows a deployed airfoil kite in accordance with some embodiments of the present invention. A lower end of tilt variation device 66 connects to tether 18 (FIG. 1). Kite wires 55 include base wires 58 and kite attachment wire sets 56. Front base wire 58a, middle base wire 58b, and rear base wire 58c extend upward from tilt variation device 66. Adjustment of tilt variation device 66 may cause small changes in the relative lengths of front and rear base wires 58a and 58c. Each base wire 58a-58c branches into a separate kite attachment wire set 56. The wires of each of the three kite attachment wire sets 56 separately attach to corresponding positions on the bottom surface of kite 54: front, middle, or rear.

Kite 54 may be provided with a kite tail 62, connected to kite 54 by tail cables 60. Kite tail 62 may interact with the wind so as to cause air intake openings 68 to face into the wind. Wind blowing into air intake openings 68 may inflate kite 54, and maintain kite 54 in an inflated state.

FIG. 3B shows an alternative design of a deployed airfoil kite, in accordance with some embodiments of the present invention. Front kite anchor set 56a connects to front kite anchor flaps 70a, middle kite anchor set 56b connects to middle kite anchor flaps 70b, and rear kite anchor set 56c connects to rear kite anchor flaps 70c. Kite anchor flaps 70a-79c also serve to stabilize alternative kite 54′ in a direction facing into the wind, eliminating the need for a tail.

The angle of attack of either kite 54 or of alternative kite 54′ may be modified to adapt to various needs. For example, the angle of attack may be varied in order to adapt to differing wind conditions. For example, the angle of attack may be adjusted so as to cause the kite to hover approximately above an anchor point for the tether. FIG. 3C shows a device for varying the angle of attack of an airfoil kite, in accordance with some embodiments of the present invention. Adjustment of handle 72 of tilt variation device 66 may vary the relative lengths of front base wire 58a and rear base wire 58c. Adjusting the relative lengths of front base wire 58a and rear base wire 58c may vary the angle of attack of kite 54 or alternative kite 54′.

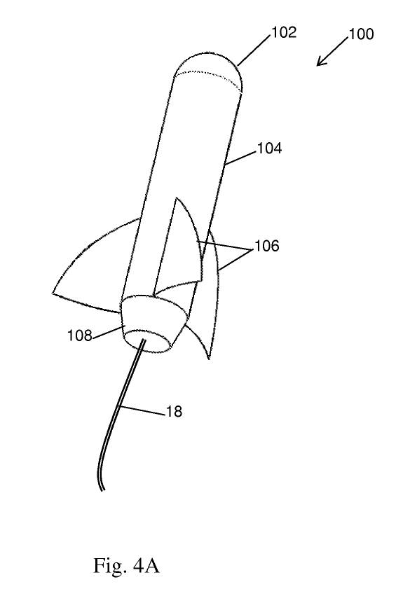

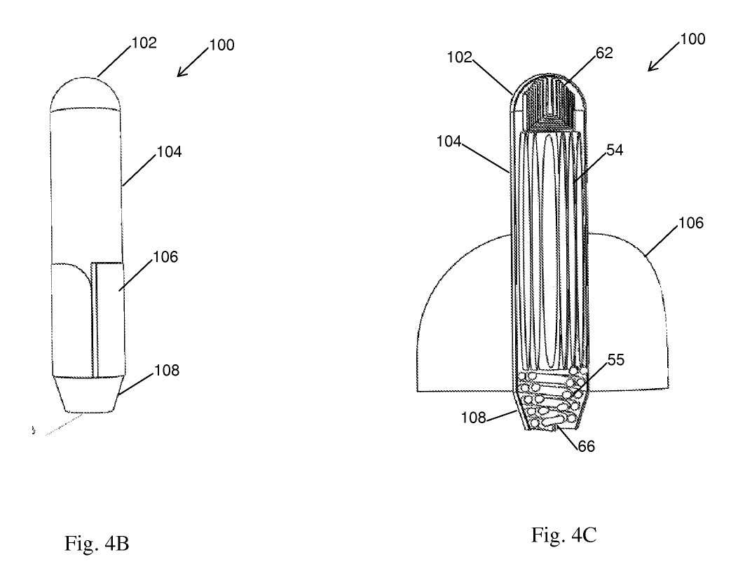

A kite in accordance with embodiments of the present invention may be launched from an appropriate launcher when the kite is in a folded state. For example, the kite may be folded in accordance with parachute folding techniques known in the art. FIG. 4A shows a launch pack containing a kite in accordance with embodiments of the present invention, after launch. Launch pack 100 is attached to an end of tether 18. As launched launch pack 100 ascends, the attached end of tether 18 is pulled upward. As the attached end of tether 18 is pulled upward, tether 18 may unwind from a reel or winch about which tether 18 is initially wrapped. Fins 106, when extended as shown, may contribute to maintaining the stability of launch pack 100 as it ascends after launch.

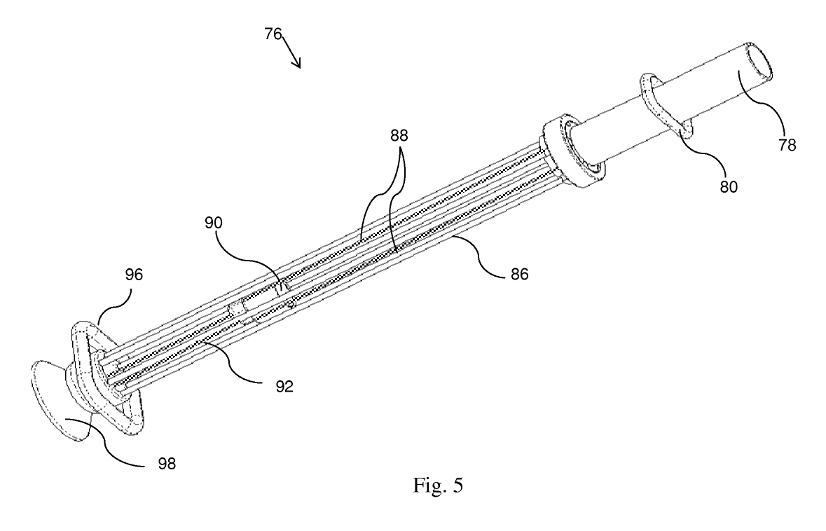

FIG. 4B shows the pack shown in FIG. 4A prior to launch. Fins 106 are folded about envelope 104 so as to facilitate fitting launch pack 100 into a launch tube of a launcher (such as launch tube 78 of FIG. 5). FIG. 4C shows the interior of the pack shown in FIG. 4A. Kite 54 is folded inside of envelope 104. Envelope 104 is typically constructed of a lightweight tearable material, such as paper. Typically, kite tail 62 may be folded into nose cone 102 of launch pack 100. Kite wires 55 are folded into tail end 108 of envelope 104. Tilt variation device 66 is accessible at tail end 108 of envelope 104. Thus, tilt variation device 66 may be adjusted by an operator for prevailing wind conditions, and may be attached to a tether, prior to launch.

When launch pack 100 ascends to a predetermined height, launch pack 100 may open to release kite 54. For example, at the predetermined height, tether 18 (FIG. 4A) may pull on tilt variation device 66 and on kite wires 55. Pulling on tilt variation device 66 and kite wires 55 may tear open envelope 104. Kite 54 and kite tail 62 may then unfurl, causing kite 54 to inflate and generate aerodynamic lift.

FIG. 5 shows a mechanical launcher for launching a kite in accordance with embodiments of the present invention. Plunger 90 of mechanical launcher 76 may be pulled toward base 98 using cocking cables 92, stretching elastic cables 88. Cocking assembly 96 may lock cocking cables 92 and plunger 90 in a cocked position. Base 98 may be placed on the ground or another surface. Base 98 may include a joint, such as a ball and socket joint, that enables aiming launch tube 78 of mechanical launcher 76 in a desired direction. For example, launch tube 78 may be aimed away from any overhanging branches or other obstructions. The orientation of mechanical launcher 76 may be held steady with the assistance of grip handle 80.

Either before or after launch tube 78 is cocked, a folded kite may be placed into launch tube 78 such that it rests on plunger 90. Typically, the folded kite is enclosed in an envelope made of a lightweight material that is easily torn, forming a cylindrical package. A tether is attached to the folded kite. A second end of the tether and most of the remainder of the tether may be wrapped around a reel of a winch. Cocking assembly 96 may then be operated to release cocking cables 92. Stretched elastic cables 88 may then contract to their lengths prior to stretching, thus propelling plunger 90 toward launch tube 78. Plunger 90 thus propels the folded kite out of launch tube 78, typically in an upward direction. Alternatively, a launcher plunger may be propelled by a by a compressed or flexed spring or other elastic element. The folded kite continues to fly upward, concurrently unwinding the tether from the reel. When the folded kite reaches a certain height, tension on the tether may open any envelope enclosing the folded kite. The tension on the tether may pull on various components of the folded kite so as to deploy the kite.

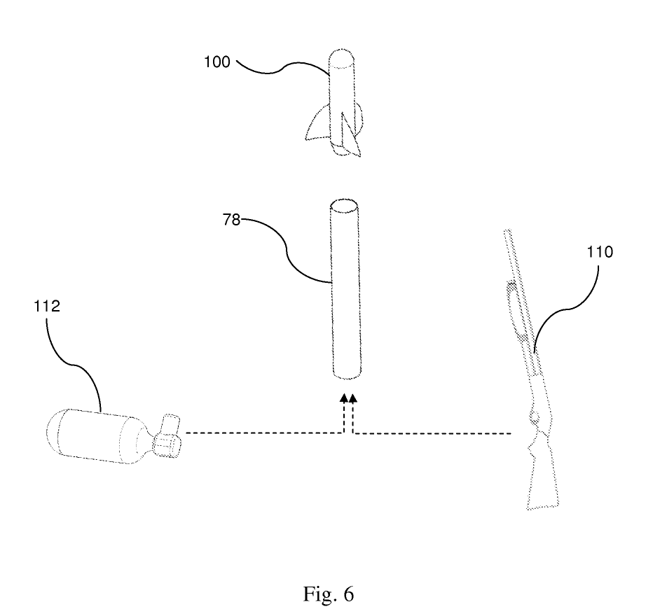

Alternatively, a launcher may be powered by other means. FIG. 6 schematically illustrates alternative launch mechanisms to the launcher shown in FIG. 5. For example, launch tube 78 may be mounted on a pyrotechnic propulsion device, represented by rifle 110. For example, in this case, launch tube 78 may include a pyrotechnic charge for propelling launch pack 100 when activated by a rifle 110 firing a blank cartridge. Alternatively, launch tube 78 may be mounted on a source of compressed gas or fluid, represent by gas cartridge 112. For example, rapid expansion of compressed gas from gas cartridge 112 may propel launch tube 100 from launch tube 78.

Once the kite is deployed, the kite may hold the tether aloft. A climbing device of a payload may be attached to the tether. The payload may then be remotely controlled to climb the tether and to operate one or more cameras or instruments.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A kite-based platform device comprising:
a passive aerodynamically-shaped structure for using aerodynamic lift to lift an end of a tether;
a payload including a motorized climbing mechanism for attaching to the tether and raising and lowering the payload along the tether.

2. A device as claimed in claim 1, wherein the structure is collapsible so as to be launchable to a predetermined altitude by a launcher and deployable at the predetermined altitude.

3. A device as claimed in claim 2, wherein the launcher is selected from a group of launchers consisting of: a mechanical launcher, a pyrotechnic launcher, and a pneumatic launcher.

4. A device as claimed in claim 2, wherein the structure when collapsed is at least partially enclosed within a tearable enclosure.

5. A device as claimed in claim 1, wherein the motorized climbing mechanism comprises a motorized pulley capable of pulling on the tether when the tether is wrapped around the pulley.

6. A device as claimed in claim 5, comprising enclosing plates angled so as to maintain contact between the pulley and the tether when the tether is wrapped around the pulley.

7. A device as claimed in claim 6, comprising a spring and a spacer for angling the enclosing plates.

8. A device as claimed in claim 1, wherein the payload comprises a gimbal axis for enabling the payload to rotate about an axis substantially perpendicular to the tether.

9. A device as claimed in claim 8, wherein the position of the gimbal axis on the payload is adjustable.

10. A device as claimed in claim 1 wherein the payload comprises stabilizing fins.

11. A device as claimed in claim 1, wherein the payload includes a connector for connecting to a sensor.

12. A device as claimed in claim 11, wherein the sensor is selected from a group of sensors consisting of: a camera, an anemometer, and a direction sensor.

13. A device as claimed in claim 1, wherein the payload comprises a communications device for communicating with a remote station.

14. A device as claimed in claim 1, wherein the structure is attachable to the tether via a plurality of attachment lines.

15. A device as claimed in claim 14, wherein the length of one or more of said two or more attachment lines is adjustable so as to adjust the angle of attack of the structure.

16. A method for deploying a kite-based platform, the method comprising:
attaching an upper end of a tether to a passive aerodynamically-shaped structure;
launching the structure to a predetermined altitude at which the structure is deployed to provide aerodynamic lift;
attaching a motorized climbing mechanism of a payload to the tether; and
operating the mechanism to raise the payload to a desired altitude.

17. A method as claimed in claim 16, comprising attaching a lower end of the tether to an anchor point.

18. A method as claimed in claim 17, comprising adjusting an angle of attack of the structure such that the deployed structure flies substantially above the anchor point.

19. A method as claimed in claim 16, wherein the step of attaching an upper end of the tether to the structure comprises attaching a plurality of attachment lines of the structure to the tether and adjusting the length of one or more of the attachment lines so as to adjust the angle of attack of the structure.

20. A method as claimed in claim 16, comprising adjusting the position of a stop on the tether so as to determine the predetermined altitude.
